(19) United States
(12) Patent Application Publication
(10) Pub. No.: US 2025/0279247 A1
(43) Pub. Date: Sep. 4, 2025

(54) METHOD FOR MANUFACTURING ELECTROLYTIC CAPACITOR AND ELECTROLYTIC CAPACITOR

(71) Applicant: Panasonic Intellectual Property Management Co., Ltd., Osaka (JP)

(72) Inventors: AKIMASA ICHIGI, Saga (JP); NOBUYUKI YAMAGUCHI, Saga (JP)

(21) Appl. No.: 19/047,763

(22) Filed: Feb. 7, 2025

(30) Foreign Application Priority Data
Feb. 29, 2024 (JP) 2024-030336

(51) Int. Cl. H01G 9/028; H01G 9/00; H01G 9/15

(52) U.S. Cl. CPC H01G 9/028; H01G 9/0036; H01G 9/15

(57) ABSTRACT

A method for manufacturing an electrolytic capacitor includes the steps of: preparing an anode body that includes a dielectric layer provided on a surface of the anode body; and forming a solid electrolyte. The step of forming the solid electrolyte includes substep A of bringing a treatment liquid containing a conjugated polymer and a polymer dopant into contact with the anode body, and at least one of (i) or (ii) below. (i) Substep B is further performed after the substep A to bring an aqueous solution containing a compound that generates an organic anion and a divalent metal ion (excluding a transition metal ion) into contact with the anode body. (ii) Substep C is further performed before the substep A to prepare the treatment liquid by mixing the aqueous solution containing the compound with a liquid composition containing the conjugated polymer and the polymer dopant.

### BACKGROUND

### 1. Technical Field

The present disclosure relates to a method for manufacturing an electrolytic capacitor, and the electrolytic capacitor.

### 2. Description of the Related Art

An electrolytic capacitor includes an anode body, a dielectric layer formed on a surface of the anode body, and a solid electrolyte (conductive polymer) covering at least a part of the dielectric layer, for example. The solid electrolyte is formed on the dielectric layer by in-situ polymerization such as chemical polymerization, for example. The solid electrolyte may be also formed by applying a liquid composition containing a conductive polymer (such as a conjugated polymer and a dopant) onto the dielectric layer and drying the liquid composition.

International Publication WO2005/014692 proposes a conductive polymer in which a matrix of a conductive polymer obtained by oxidative polymerization is coated with at least one organic sulfonic acid salt composed of an anion of an organic sulfonic acid and a cation other than a transition metal, or the matrix of the conductive polymer obtained by oxidative polymerization contains at least one organic sulfonic acid salt composed of the anion of the organic sulfonic acid and the cation other than the transition metal.

### SUMMARY

A first aspect of the present disclosure is a method for manufacturing an electrolytic capacitor including a capacitor element containing a solid electrolyte, the method including the steps of:
preparing an anode body that includes a dielectric layer provided on a surface of the anode body; and
forming a solid electrolyte covering at least a part of the dielectric layer.

The step of forming the solid electrolyte includes:
substep A of bringing a treatment liquid containing a conjugated polymer and a polymer dopant into contact with the anode body, and
at least one of (i) or (ii) below,
(i) substep B is further performed after the substep A to bring an aqueous solution containing a compound that generates an organic anion and a divalent metal ion into contact with the anode body, the divalent metal ion not including a divalent transition metal ion, and
(ii) substep C is further performed before the substep A to prepare the treatment liquid by mixing an aqueous solution containing a compound that generates an organic anion and a divalent metal ion with a liquid composition containing the conjugated polymer and the polymer dopant, the divalent metal ion not including a divalent transition metal ion.

A second aspect of the present disclosure is an electrolytic capacitor including a capacitor element containing a solid electrolyte, the electrolytic capacitor including:
an anode body with a surface provided with a dielectric layer; and
a solid electrolyte covering at least a part of the dielectric layer, the solid electrolyte containing a metal element corresponding to a divalent metal ion, the divalent metal ion not including a divalent transition metal ion.

The solid electrolyte includes a first conductive polymer layer containing a conjugated polymer, a polymer dopant, and the metal element, and
the metal element is dispersed throughout the first conductive polymer layer.

When the electrolytic capacitor is exposed to a high humidity environment, equivalent series resistance (ESR) can be reduced in fluctuation.

### BRIEF DESCRIPTION OF THE DRAWING

FIG. 1 is a schematic sectional view illustrating an electrolytic capacitor according to an exemplary embodiment of the present disclosure.

### DETAILED DESCRIPTIONS OF EMBODIMENTS

Hereinafter, problems of the prior art will be briefly described.

In a high-humidity (e.g., 70% RH or more) environment, moisture enters an electrolytic capacitor, and a dopant component is eluted into the moisture. The eluted dopant component diffuses into the electrolytic capacitor (particularly in a solid electrolyte) to lower the pH. When the pH partially decreases in the electrolytic capacitor, dedoping further proceeds to lower electric conductivity of the solid electrolyte. When the conductivity of the solid electrolyte decreases, fluctuation of ESR becomes remarkable. The fluctuation of the ESR is remarkable at a relatively high temperature (e.g., a temperature ranging from 60° C. to 120° C., inclusive).

When the electrolytic capacitor is exposed to a high-humidity environment, reducing fluctuation of the ESR is important.
(Technique 1) In view of the above, a method for manufacturing an electrolytic capacitor according to a first aspect of the present disclosure is a method for manufacturing an electrolytic capacitor including a capacitor element containing a solid electrolyte. The method for manufacturing an electrolytic capacitor includes the steps of: preparing an anode body that includes a dielectric layer provided on a surface of the anode body; and forming a solid electrolyte covering at least a part of the dielectric layer. The step of forming the solid electrolyte includes substep A of bringing a treatment liquid containing a conjugated polymer and a polymer dopant into contact with the anode body. Further, the step of forming the solid electrolyte includes at least one of (i) or (ii) below:
(i) substep B is further performed after the substep A to bring an aqueous solution containing a compound that generates an organic anion and a divalent metal ion (excluding a divalent transition metal ion) into contact with the anode body; and
(ii) substep C is further performed before the substep A to prepare the treatment liquid by mixing an aqueous solution containing a compound that generates an organic anion and a divalent metal ion (excluding a divalent transition metal ion) with a liquid composition containing the conjugated polymer and the polymer dopant.

According to the present disclosure, the step of forming a solid electrolyte includes the substep A, and at least one of the substep B or the substep C. Specific examples of the compound that generates an organic anion and a divalent metal ion include a salt of an organic anion and a divalent metal ion. Using a compound as described above in the step of forming a solid electrolyte using a treatment liquid containing a conjugated polymer and a polymer dopant enables reduction in fluctuation of the ESR when the electrolytic capacitor is exposed to a high-humidity environment. This is considered to be because the divalent metal ion derived from the above compound traps the dopant eluted into moisture to suppress a decrease in pH in the solid electrolyte. Suppressing the decrease in pH in the solid electrolyte suppresses further dedoping. It is considered that a decrease in conductivity of the solid electrolyte is suppressed and fluctuation of the ESR is suppressed due to the reason above. This kind of effect is also obtained when the electrolytic capacitor is exposed to a relatively high temperature and high humidity environment, and is remarkable as compared with when both (i) and (ii) are not satisfied.
(Technique 2) In the above (Technique 1), the organic anion may include an aromatic sulfonic acid anion. The aromatic sulfonic acid anion is likely to be dissociated in an aqueous solution or a treatment liquid, so that a divalent metal ion is also likely to be generated from the compound. Thus, effect of trapping the dopant can be enhanced.
(Technique 3) In the above (Technique 1) or (Technique 2), the divalent metal ion may be at least one kind of ion selected from the group consisting of a barium ion, a calcium ion, and a magnesium ion. Salts of the divalent metal ion described above and the organic anion are likely to be moderately dissociated in an aqueous solution or a treatment liquid. The divalent metal ion described above also causes capacitor performance to be less likely to be deteriorated, and the dopant to be likely to be trapped.
(Technique 4) In any one of (Technique 1) to (Technique 3), the step of forming the solid electrolyte may further include substep D of polymerizing a precursor of a conjugated polymer in presence of a dopant while a polymerization liquid containing the precursor and the dopant is in contact with the anode body. In this case, the substep A is performed after the substep D. To cover at least a part of the dielectric layer of the anode body, a second conductive polymer layer is formed from the polymerization liquid by in-situ polymerization. Then, to cover at least a part of the second conductive polymer layer, a first conductive polymer layer containing the conjugated polymer and the polymer dopant is formed. The divalent metal ion (or a metal element corresponding to the divalent metal ion) exists by being dispersed in the first conductive polymer layer. This configuration enables suppressing dedoping while reducing a leakage current. Thus, the ESR can be further reduced in fluctuation when the electrolytic capacitor is exposed to a high-humidity environment.
(Technique 5) In any one of (Technique 1) to (Technique 4), a concentration of the compound that generates the organic anion and the divalent metal ion in the aqueous solution in (i) may range from 1% by mass to 10% by mass, inclusive. In this case, the divalent metal ions can be more uniformly dispersed in the solid electrolyte to not only enhance the effect of trapping the dopant but also suppress the leakage current.
(Technique 6) In any one of (Technique 1) to (Technique 5), a concentration of the compound that generates the organic anion and the divalent metal ion in the treatment liquid in (ii) may range from 0.2% by mass to 3.0% by mass, inclusive. In this case, the divalent metal ions can be more uniformly dispersed in the solid electrolyte to not only enhance the effect of trapping the dopant but also suppress the leakage current.
(Technique 7) In any one of (Technique 1) to (Technique 6) described above, a step of subjecting the anode body to heat treatment may be further provided after the substep A, or after the substep B when the substep B is performed. In the step of subjecting the anode body to heat treatment, the heat treatment may be performed at a temperature ranging from 80° C. to 150° C., inclusive, for five minutes or more. This kind of heat treatment step enables not only the divalent metal ions to be fixed while being more uniformly dispersed in the solid electrolyte, but also the dopant to be efficiently trapped by the divalent metal ions even when the dopant is eluted by ingress of moisture.
(Technique 8) An electrolytic capacitor according to a second aspect of the present disclosure includes a capacitor element including a solid electrolyte. The electrolytic capacitor includes an anode body that includes a dielectric layer provided on a surface of the anode body, and a solid electrolyte covering at least a part of the dielectric layer. The solid electrolyte contains a metal element corresponding to a divalent metal ion (excluding a divalent transition metal ion). The solid electrolyte includes a first conductive polymer layer containing a conjugated polymer, a polymer dopant, and the metal element. The metal element is dispersed throughout the first conductive polymer layer. Hereinafter, the metal element corresponding to the divalent metal ion (excluding the divalent transition metal ion) may be referred to as a first metal element.

The first metal element is dispersed throughout the first conductive polymer layer, so that a divalent metal ion corresponding to the first metal element traps a dopant throughout the first conductive polymer layer even when moisture penetrates into the first conductive polymer layer to elute the dopant. Consequently, a decrease in pH in the first conductive polymer layer is suppressed, and further dedoping is suppressed. Thus, the ESR can be reduced in fluctuation when the electrolytic capacitor is exposed to a high-humidity environment (particularly, an environment of relatively high temperature and high humidity).
(Technique 9) In the above (Technique 8), the metal element may be at least one kind of element selected from the group consisting of a barium element, a calcium element, and a magnesium element. Divalent metal ions corresponding to these metal elements are likely to be moderately dissociated in an aqueous solution or a treatment liquid, and are likely to diffuse into the first conductive polymer layer. The divalent metal ion described above also causes capacitor performance to be less likely to be deteriorated, and the dopant to be likely to be trapped.
(Technique 10) In the above (Technique 8) or (Technique 9), the solid electrolyte may further include a second conductive polymer layer covering at least a part of the dielectric layer. The first conductive polymer layer covers at least a part of the second conductive polymer layer. The second conductive polymer layer may contain a conjugated polymer and a dopant. A content ratio of the metal element (first metal element) in the first conductive polymer layer is a higher than a content ratio of the metal element (first metal element) in the second conductive polymer layer. The first conductive polymer layer contains a polymer dopant, and is usually formed using a treatment liquid containing at least a conjugated polymer and the polymer dopant. The first conductive polymer layer described above usually occupies a large part of the solid electrolyte. Many first metal elements are dispersed throughout the first conductive polymer layer, so that an eluted dopant is more likely to be trapped. Consequently, a decrease in pH of the first conductive polymer layer can be suppressed, and the ESR can be further reduced in fluctuation.
(Technique 11) In any one of (Technique 8) to (Technique 10), the electrolytic capacitor may include a carbon layer covering at least a part of a surface of the first conductive polymer layer. In the electrolytic capacitor after being allowed to stand at 85° C. and 85% RH for 1000 hours while a voltage of 0.8 times a rated voltage is applied, the metal element (first metal element) may be segregated on an interface between the first conductive polymer layer and the carbon layer in the first conductive polymer layer. When the electrolytic capacitor is allowed to stand under the above conditions, the first metal element contained in the first conductive polymer layer is likely to be ionized and moved by influence of moisture and voltage application, and thus segregates on the interface. The dopant eluted in moisture in the first conductive polymer layer is trapped while the first metal element (or divalent metal ion) moves, so that even when a long time elapses while voltage is applied at a high temperature and a high humidity as described above, a decrease in conductivity of the first conductive polymer layer can be suppressed to suppress fluctuation of the ESR.

Hereinafter, the method for manufacturing an electrolytic capacitor and the electrolytic capacitor according to the present disclosure including the above (Technique 1) to (Technique 11) will be described in more detail with reference to the drawings as needed. To the extent that there is no technical contradiction, at least one of the above (Technique 1) to (Technique 11) and at least one of the elements described below may be combined.

### [Method for Manufacturing Electrolytic Capacitor]

The electrolytic capacitor of the present disclosure includes the capacitor element that includes an anode part and a cathode part, for example. The anode part includes an anode body. The anode part may include the anode body and an anode wire. The cathode part may include a solid electrolyte, and the cathode part may include the solid electrolyte and a cathode lead-out layer.

The method for manufacturing an electrolytic capacitor according to the present disclosure includes the steps of: preparing the anode body that includes a dielectric layer provided on a surface of the anode body (first step); and forming the solid electrolyte covering at least a part of the dielectric layer (second step). The method for manufacturing an electrolytic capacitor may further include a step (third step) of forming the cathode lead-out layer covering at least a part of the solid electrolyte. Through the first to third steps, the capacitor element provided in the electrolytic capacitor is formed. The method for manufacturing an electrolytic capacitor may further include a step of connecting an anode lead terminal and a cathode lead terminal to the capacitor element, a step of sealing the capacitor element in a case or with an exterior body (such as a resin exterior body), and the like.

### (First Step)

The first step may include a substep of preparing the anode body and a substep of forming the dielectric layer on a surface of the anode body, for example. Through these substeps, the anode body that includes a dielectric layer provided on a surface of the anode body is prepared.

The anode body may contain a valve metal, an alloy containing the valve metal, a compound containing the valve metal, and the like. One kind of material of these materials may be singly used or a combination of two or more kinds of material of these materials may be used. Preferable examples of the valve metal include aluminum, tantalum, niobium, and titanium.

The anode body may be anode foil, or may be a porous sintered body or a porous molded body of particles containing the valve metal. The porous sintered body or the porous molded body, and each porous sintered body, may have a sheet shape, a rectangular parallelepiped shape, a cubic shape, or a shape similar thereto.

From the viewpoint of obtaining a high capacitance, the anode body preferably includes a porous part at least on its surface layer. The anode body includes many fine voids in the porous part. This kind of porous part allows the anode body to have a fine uneven shape. The sintered body or the molded body described above may be entirely a porous part. Each of the porous sintered body and the porous molded body may have a sheet shape, a rectangular parallelepiped shape, a cubic shape, or a shape similar thereto, as a whole.

The anode body with the surface layer provided with the porous part is obtained by roughening a surface of a base material (e.g., a base material in a sheet shape, such as a foil shape or a plate shape, etc.) containing the valve metal, for example. The roughening may be performed by etching (electrolytic etching, chemical etching, etc.) or the like, for example. This kind of anode body includes a porous part formed integrally with a core part of the anode body, the porous part existing in both surfaces of the core part and the core part, for example. As the anode body, a porous sintered body containing a Ta element is preferable.

The anode body may include an anode lead-out part including a first end part, and a cathode formation part including a second end part opposite to the first end part. The cathode formation part of the anode body has a surface on which the cathode part including the solid electrolyte is formed. The anode lead-out part is used for electrical connection with an external electrode at a side close to the anode, for example. The anode lead-out part may be connected to the anode lead terminal.

When the anode body is a porous sintered body or a porous molded body, the anode part may include the anode wire. In this case, the first step may include a step of preparing the anode wire, a step of embedding the anode wire in the anode body, and the like. The anode part including the anode body and the anode wire is formed by embedding one end part of the anode wire in the anode body.

The anode wire may be a wire made of metal. Examples of the material of the anode wire include the valve metal described above, copper, and a copper alloy. The anode wire includes a part embedded in the anode body, and a remaining part protruding outward from an end surface of the anode body. The anode wire protruding outward has an end part corresponding to the first end part, and the anode body has an end part opposite to the first end part, the end parts corresponding to the second end part.

In the first step, the dielectric layer is further formed on the surface of the anode body. The dielectric layer is formed by anodizing the valve metal on the surface of the anode body. The anodizing is performed by anodizing treatment, for example. The dielectric layer is formed covering at least a part of the surface of the anode body, for example.

The dielectric layer contains an oxide of the valve metal. For example, when tantalum is used as the valve metal, the dielectric layer contains Ta₂O₅, and when aluminum is used as the valve metal, the dielectric layer contains Al₂O₃. The dielectric layer is not limited to the ones described above, and any dielectric layer may be used as long as the dielectric layer functions as a dielectric material.

The dielectric layer is usually formed on the surface of the anode body. When the dielectric layer is formed on a surface of the porous part of the anode body, the dielectric layer is formed along a pore of the porous part and an inner wall surface of a dent (pit) in the surface of the anode body.

### (Second Step)

In the second step, the solid electrolyte layer is formed covering at least a part of the dielectric layer. The second step includes substep A of bringing the treatment liquid containing the conjugated polymer and the polymer dopant into contact with the anode body including the dielectric layer. The treatment liquid may be a liquid dispersion or a solution. Examples of a liquid medium contained in the treatment liquid include water, an organic liquid medium (such as a water-soluble organic liquid medium), and a mixture thereof.

In the present disclosure, it is important to satisfy at least one of (i) or (ii) below. Consequently, the solid electrolyte contains the first metal element corresponding to the divalent metal ion. Even when moisture penetrates into the solid electrolyte in a high humidity environment to elute a dopant into the moisture in the solid electrolyte, the dopant is trapped by the divalent metal ion to suppress a decrease in pH of the surroundings, and thus fluctuation of the ESR is reduced.
(i) The second step further includes substep B after the substep A to bring an aqueous solution containing a compound that generates an organic anion and a divalent metal ion (excluding a divalent transition metal ion) into contact with the anode body including the dielectric layer.
(ii) The second step further includes substep C before the substep A to prepare a treatment liquid by mixing the aqueous solution containing the compound that generates the organic anion and the divalent metal ion (excluding the divalent transition metal ion) with a liquid composition containing a conjugated polymer and a polymer dopant.

Examples of the organic anion include an organic sulfonic acid anion, an organic phosphonic acid anion, an organic phosphinic acid anion, and an organic carboxylic acid anion. The organic anion may be any one of aliphatic, alicyclic, and aromatic. The organic anion may include a heteroatom (nitrogen atoms, sulfur atoms, oxygen atoms, and the like) in an organic moiety. The compound may contain one kind of organic anion or two or more kinds of organic anion. From the viewpoint in which the divalent metal ion is likely to be dissociated in the aqueous solution or the treatment liquid, the organic anion preferably contains an organic sulfonic acid anion, and particularly preferably contains an aromatic sulfonic acid anion.

The divalent metal ion preferably contains a group II metal ion of the periodic table. In particular, the divalent metal ion is preferably at least one kind of ion selected from the group consisting of a barium ion, a calcium ion, and a magnesium ion.

To the aqueous solution or the treatment liquid, a compound capable of generating an organic anion and a divalent metal ion is added to generate the organic anion and the divalent metal ion in the aqueous solution or the treatment liquid. The aqueous solution or the treatment liquid containing these ions are used in substep B or substep C of the second step. This kind of compound may be a salt of the organic anion and the divalent metal ion.

A concentration of the compound that generates the organic anion and the divalent metal ion in the aqueous solution in (i) above may be 10% by mass or less, or 7% by mass or less. A concentration of the compound in the aqueous solution may be 1% by mass or more. When a concentration of the compound in the aqueous solution is in such a range, divalent metal ions can be more uniformly dispersed in the solid electrolyte, and thus the effect of trapping the dopant is enhanced.

A concentration of the compound that generates the organic anion and the divalent metal ion in the treatment liquid in (ii) above may range from 0.2% by mass to 3.0% by mass, inclusive, or from 0.3% by mass to 2.5% by mass, inclusive. When a concentration of the compound in the treatment liquid is in such a range, divalent metal ions can be more uniformly dispersed in the solid electrolyte, and thus the effect of trapping the dopant is enhanced.

The second step may further include a step of subjecting the anode body, to which the treatment liquid has been applied, to heat treatment after the substep A. When the second step includes the substep B, the second step may further include a step after substep B, the step being provided to subject the anode body, to which the aqueous solution is applied, to the heat treatment. Through these heat treatment steps, the liquid medium contained in the applied treatment liquid or aqueous solution is dried.

Temperature in each heat treatment step can be selected in accordance with a kind of the liquid medium. The temperature of the heat treatment step may range from 80° C. to 150° C., inclusive, or from 95° C. to 120° C., inclusive.

Heating time in the heat treatment step may be one minute or more, five minutes or more, or ten minutes or more. The heat treatment for five minutes or more enables the liquid medium (in particular, moisture) to be effectively removed. The heating time may be 60 minutes or less.

The second step may include substep D prior to the substep A. In the substep D, a polymerization liquid containing a precursor of the conjugated polymer and the dopant is brought into contact with the anode body including the dielectric layer, and the precursor is polymerized with the dopant existing. In the substep D, polymerization of the precursor proceeds on the dielectric layer to form the second conductive polymer layer containing the conjugated polymer and the dopant. The second conductive polymer layer is formed covering at least a part of the dielectric layer. Then, in the substep A, the first conductive polymer layer is formed covering at least a part of the second conductive polymer layer so that the solid electrolyte (i.e., the solid electrolyte layer) that includes the second conductive polymer layer and the first conductive polymer layer is formed. When at least one of (i) or (ii) above is satisfied, the divalent metal ion (or the first metal element corresponding to the divalent metal ion) can be dispersed and present in the first conductive polymer layer. Accordingly, dedoping can be suppressed. Thus, the ESR can be further reduced in fluctuation when the electrolytic capacitor is exposed to a high-humidity environment.

In the solid electrolyte, the anionic group (a sulfo group, a carboxy group, etc.) of the organic anion may be contained in a free form, an anion form, or a salt form, or may be contained in a form bonded to or interacting with another component such as the conjugated polymer. All of these forms herein may be simply referred to as an “anionic group”, a “sulfo group”, a “carboxy group”, or the like.

Examples of the conjugated polymer contained in the solid electrolyte (each of the first conductive polymer layer and the second conductive polymer layer) include a π-conjugated polymer. Examples of the conjugated polymer described above include a polymer having polypyrrole, polythiophene, polyaniline, polyfuran, polyacetylene, polyphenylene, polyphenylene vinylene, polyacene, or polythiophene vinylene as a basic skeleton. The polymer is required to contain at least one monomer unit constituting the basic skeleton. The monomer unit also includes a monomer unit having a substituent. The polymer also includes a homopolymer, and a copolymer of two or more monomers. Examples of polythiophene include poly(3,4-ethylenedioxythiophene) (PEDOT).

Examples of the polymer dopant contained in the solid electrolyte or the first conductive polymer layer include a polymer anion. Examples of the polymer dopant include a polymer having a plurality of sulfo groups. The polymer dopant may have not only the sulfo group but also another anionic group (e.g., a carboxy group).

Examples of the polymer dopant having a sulfo group include a polymer-type polysulfonic acid. Specific examples of the polymer dopant include polyvinylsulfonic acid, polystyrenesulfonic acid (including a copolymer and a substitution product having a substituent), polyallylsulfonic acid, polyacrylsulfonic acid, polymethacrylsulfonic acid, poly(2-acrylamide-2-methylpropanesulfonic acid), polyisoprenesulfonic acid, polyestersulfonic acid (aromatic polyester sulfonic acid or the like), and phenolsulfonic acid novolac resin. However, the polymer dopant is not limited to these specific examples. The solid electrolyte or the first conductive polymer layer may contain one kind of polymer dopant or may contain two or more kinds of polymer dopant in combination.

A total concentration of the conjugated polymer and the polymer dopant in the treatment liquid may range from 1% by mass to 6% by mass, inclusive, or from 2% by mass to 4% by mass, inclusive.

When the second conductive polymer layer is formed, a polymerization liquid containing a precursor and a dopant of the conjugated polymer is used, for example. Examples of the dopant include aromatic sulfonic acid (naphthalenesulfonic acid, p-toluenesulfonic acid, and the like). However, the dopant is not limited to these dopants.

The polymerization liquid may contain an oxidizing agent. The oxidizing agent may have a function as a dopant. Examples of the oxidizing agent include a compound capable of generating Fe³⁺ (such as a ferric sulfate or iron p-toluenesulfonate), a persulfate (such as a sodium persulfate or an ammonium persulfate), and a hydrogen peroxide. One kind of oxidizing agent can be used singly, or two or more kinds of oxidizing agent can be used in combination.

Examples of the precursor of the conjugated polymer include a raw material monomer of the conjugated polymer, and an oligomer and a prepolymer in which a plurality of molecular chains of the raw material monomer are linked. One kind of precursor may be used, or two or more kinds of precursor may be used in combination.

The polymerization liquid usually contains a solvent. Examples of the solvent include water, an organic solvent, and a mixed solvent of water and an organic solvent (such as a water-soluble organic solvent).

In the solid electrolyte, the polymer dopant or the anionic group (a sulfo group, a carboxy group, etc.) of the dopant may be contained in a free form, an anion form, or a salt form, or may be contained in a form bonded to or interacting with the conjugated polymer. All of these forms herein may be simply referred to as an “anionic group”, a “sulfo group”, a “carboxy group”, or the like.

In the present disclosure, when the second step satisfies at least one of (i) or (ii) above, a content ratio of the first metal element in the first conductive polymer layer can be higher than a content ratio of the first metal element in the second conductive polymer layer. Consequently, an initial low ESR is likely to be obtained, and fluctuation of the ESR can be further reduced when the electrolytic capacitor is exposed to a high-humidity environment for a long time.

### (Third Step)

In the third step, the cathode lead-out layer may be formed. The cathode lead-out layer is formed covering at least a part of the solid electrolyte.

The cathode lead-out layer may include at least a first layer that is in contact with the solid electrolyte while covering at least a part of the solid electrolyte layer, and may include the first layer and a second layer covering the first layer. The first layer may be formed covering at least a part of the solid electrolyte. The second layer may be further laminated covering the first layer formed. In this way, the cathode lead-out layer is formed. Each of layers is formed in accordance with a type of corresponding one of the layers.

Examples of the first layer include a layer containing conductive particles, and metal foil. Examples of the conductive particles include at least one kind selected from conductive carbon and metal powder. For example, the cathode lead-out layer may include a layer containing conductive carbon (also referred to as a carbon layer) as the first layer and a layer containing metal powder or metal foil as the second layer. When the metal foil is used as the first layer, the metal foil may constitute the cathode lead-out layer.

Examples of the conductive carbon include graphite (artificial graphite, natural graphite, and the like). The carbon layer is formed by applying a composition (such as slurry or paste) containing conductive carbon to cover at least a part of the solid electrolyte, and drying the composition, for example. The composition may contain resin (binder resin). As the resin, a thermoplastic resin may be used, or a thermosetting resin such as an imide resin or an epoxy resin may be used.

The layer containing metal powder as the second layer can be formed by stacking a composition (such as paste) containing metal powder on a surface of the first layer, for example. Examples of this kind of second layer include a metal particle-containing layer (such as a metal-paste layer) formed by using a composition containing metal powder such as silver particles and resin (binder resin). Although a thermoplastic resin may be used for the resin, use of a thermosetting resin such as an imide resin or an epoxy resin is preferable.

The metal foil is disposed to be stacked on a layer serving as a base (such as the solid electrolyte). When the metal foil is used as the first layer, a kind of metal is not particularly limited. The metal foil is preferably formed using a valve metal such as aluminum, tantalum, or niobium, or an alloy containing the valve metal. The metal foil has a surface that may be roughened as necessary. The surface of the metal foil may be provided with an anodization film, and may be provided with a film of metal (dissimilar metal) different from the metal constituting the metal foil, or a nonmetal film. Examples of the dissimilar metal and the nonmetal include metal such as titanium, and nonmetal such as carbon (such as conductive carbon).

The first layer may be formed of a film of the dissimilar metal or the nonmetal (e.g., conductive carbon), and the second layer may be formed of the metal foil described above.

### (Others)

The method for manufacturing an electrolytic capacitor may further include a step of connecting an anode lead terminal and a cathode lead terminal to the capacitor element, a step of sealing the capacitor element in a case or with an exterior body (such as a resin exterior body), and the like.

In the capacitor element, one end part of the cathode lead terminal may be electrically connected to the cathode lead-out layer. For example, a conductive adhesive is applied to the cathode lead-out layer, and the cathode lead terminal is bonded to the cathode lead-out layer with the conductive adhesive interposed therebetween. The anode lead terminal may be electrically connected at its one end part to the anode lead-out part of the anode body. The anode lead terminal and the cathode lead terminal each have the other end part that is drawn out from the resin exterior body or the case. The other end of each terminal exposed from the resin exterior body or the case is used for solder connection to a substrate on which the solid electrolytic capacitor is to be mounted, for example. Besides a case where the lead terminal is drawn out, an end surface of at least one of the anode part and the cathode part may be exposed from an outer surface of a sealing body to be electrically connected to the external electrode.

The capacitor element is sealed using the resin exterior body or the case. For example, the capacitor element and a material resin (e.g., uncured thermosetting resin and filler) of the exterior body may be housed in a mold to seal the capacitor element with the resin exterior body by a transfer molding method, a compression molding method, or the like. At this time, parts of the anode lead terminal connected to the anode lead and drawn out from the capacitor element, and the cathode lead terminal, the parts being close to the respective other end parts of the anode lead terminal and the cathode lead terminal, are exposed from the mold. The solid electrolytic capacitor may be formed by housing the capacitor element in a bottomed case while the parts of the anode lead terminal and the cathode lead terminal, the parts being close to the respective other end parts thereof, are positioned close to an opening of the bottomed case, and sealing the opening of the bottomed case using a sealing body. A lead may have a wire shape or a frame shape (such as a lead frame).

### [Electrolytic Capacitor]

The electrolytic capacitor according to the second aspect of the present disclosure includes the capacitor element including the solid electrolyte. This kind of electrolytic capacitor is formed by the above-described method for manufacturing an electrolytic capacitor, for example. Components of the electrolytic capacitor can be referred to the description of the method for manufacturing an electrolytic capacitor.

The electrolytic capacitor of the present disclosure includes the anode body that includes a dielectric layer provided on a surface of the anode body, and the solid electrolyte covering at least a part of the dielectric layer. The solid electrolyte contains the metal element (first metal element) corresponding to the divalent metal ion (excluding the divalent transition metal ion). In the electrolytic capacitor, the solid electrolyte may constitute a solid electrolyte layer.

The solid electrolyte includes a conjugated polymer (first conjugated polymer), a polymer dopant (first dopant), and a first conductive polymer layer containing a first metal element. The solid electrolyte may include the second conductive polymer layer covering at least a part of the dielectric layer, and the first conductive polymer layer covering at least a part of the second conductive polymer layer. The second conductive polymer layer may contain a conjugated polymer (second conjugated polymer) and a dopant (second dopant).

As described above, a content ratio of the first metal element in the first conductive polymer layer may be higher than a content ratio of the first metal element in the second conductive polymer layer. This content ratio is obtained by forming the solid electrolyte (in particular, the first conductive polymer layer) to satisfy at least one of (i) or (ii) in the second step of the method for manufacturing an electrolytic capacitor.

Each of the solid electrolyte, the first conductive polymer layer, and the second conductive polymer layer includes the first metal element that is not particularly limited in form. For example, at least one kind selected from the group consisting of a barium element, a calcium element, and a magnesium element may be dispersed throughout the first conductive polymer layer. In each of the solid electrolyte, the first conductive polymer layer, and the second conductive polymer layer, the first metal element may be contained in a form of a metal ion, in a state of interacting with or bonding with a metal ion and another component such as a dopant or a polymer dopant, or in a form of a compound containing a salt or the like.

The first metal element may be dispersed throughout the first conductive polymer layer. The first metal element is dispersed throughout the first conductive polymer layer, so that the eluted dopant can be trapped and a decrease in pH can be suppressed, and thus further dedoping can be suppressed. Thus, fluctuation of the ESR when the electrolytic capacitor is exposed to a high-humidity environment can be reduced.

For example, when a thickness of the first conductive polymer layer is represented by T, an existence probability Pb and an existence probability Pt may satisfy a relationship of “0.8<Pb/Pt<1.2” where, in the first conductive polymer layer, the existence probability Pb is an existence probability of the first metal element in a region from the surface of the dielectric layer to a position at 0.5 T from the surface of the dielectric layer, and the existence probability Pt is an existence probability of the first metal element in a region from the position at 0.5 T to an outermost surface of the first conductive polymer layer.

When the electrolytic capacitor is allowed to stand at 85° C. and 85% RH for 1000 hours while applying a voltage 0.8 times the rated voltage, in the electrolytic capacitor after being allowed to stand, the first metal element segregates on a surface of the first conductive polymer layer, the surface being opposite to the dielectric layer. The first conductive polymer layer includes the surface opposite to the dielectric layer, the surface corresponding to an interface between the first conductive polymer layer and the cathode lead-out layer (the first layer such as a carbon layer) when at least a part of the first conductive polymer layer is covered with the cathode lead-out layer (the first layer such as a carbon layer). Thus, the first metal element may be segregated on this interface. Even in such a case, fluctuation of the ESR can be reduced by suppressing a decrease in conductivity of the first conductive polymer layer.

The electrolytic capacitor or the capacitor element contains elements in a distribution state that is analyzed by applying element mapping using an electron probe micro analyzer (EPMA) to a section of the electrolytic capacitor or the capacitor element.

The EPMA analysis is performed using a sample acquired by exposing a section of a part of the electrolytic capacitor or the capacitor element, the part being provided with the anode body and the cathode part containing the solid electrolyte, and forming a platinum film on the section. In a sectional image of the anode body on which the cathode part is formed, the element mapping is performed on a region from the anode body to an outermost surface of the cathode lead-out layer using a difference in wavelength of characteristic X-rays from the EPMA to measure Net intensity of contained elements. The Net intensity is obtained by removing a background (noise) from a measured value of each element. The Net intensity of an element to be analyzed (the first metal element, an S element contained in the conductive polymer, and the like) is acquired in a specific part (the first conductive polymer layer, the second conductive polymer layer, a surface layer part of the solid electrolyte, the surface layer part being opposite to the dielectric layer, an interface between the first conductive polymer layer and the first layer of the cathode lead-out layer, a surface of the second layer of the cathode lead-out layer and in the vicinity of the surface of the second layer, and the like) of the solid electrolyte layer. The Net intensity of the element to be analyzed is acquired in a plurality of regions (e.g., five regions) for each one part to calculate an average of values of the Net intensity, so that a relative existence ratio of the element to be analyzed in each part can be grasped.

Conditions of the EPMA analysis are as follows.
Measurement apparatus: JSM-7900F (field emission scanning electron microscope) manufactured by JEOL Ltd.
Detector: XM-86030 manufactured by JEOL Ltd.
Environment at the time of measurement: 25° C., atmospheric pressure
Acceleration voltage: 15.0 kV
Beam current: 50.4 nA
Integration time: 50.0 ms/point (12 minutes mode)
Analyzing crystal: AP/CH1, PbST/CH2, PET/CH3, LiF/CH4, LSA80/CH5

A sample for analysis can be produced by the following procedure, for example. First, a solid electrolytic capacitor or a capacitor element is embedded in a curable resin, and the curable resin is cured. The anode body includes a first end part and a second end part opposite to the first end part, and the solid electrolyte is formed in a part of the anode body, the part being close to the second end part. The cured product obtained above is subjected to wet polishing or dry polishing so that a section perpendicular to a length direction of the capacitor element and parallel to a thickness direction thereof is exposed at a predetermined position in a direction from the first end part toward the second end part of the anode body (i.e., a length direction of the anode body or the capacitor element). The exposed section is smoothed by ion milling. Platinum (Pt) is sputtered on the smoothed section using a sputtering apparatus to form a platinum film having a thickness of 1 nm to 2 nm. In this way, the sample for analysis is obtained. When a length of a region where the solid electrolyte is formed in a direction parallel to the length direction of the capacitor element is defined as 1, the section is defined as a section at a position of more than 0 and 0.05 or less from an end part of the region where the solid electrolyte is formed, the end part being close to the second end part. Existence probabilities Pb and Pt are also determined in accordance with the above.

In the first conductive polymer layer, the content of the polymer dopant in the solid electrolyte may range from 10 parts by mass to 1000 parts by mass, inclusive, or from 20 parts by mass to 500 parts by mass, inclusive, respect to 100 parts by mass of the conjugated polymer.

### (Others)

The electrolytic capacitor includes at least one capacitor element. The electrolytic capacitor may be a wound type, or may be either a chip type or a stack type. For example, the electrolytic capacitor may include a plurality of stacked capacitor elements. The electrolytic capacitor may also include two or more wound type capacitor elements. The capacitor element may have a configuration selected suitable for a type of the electrolytic capacitor.

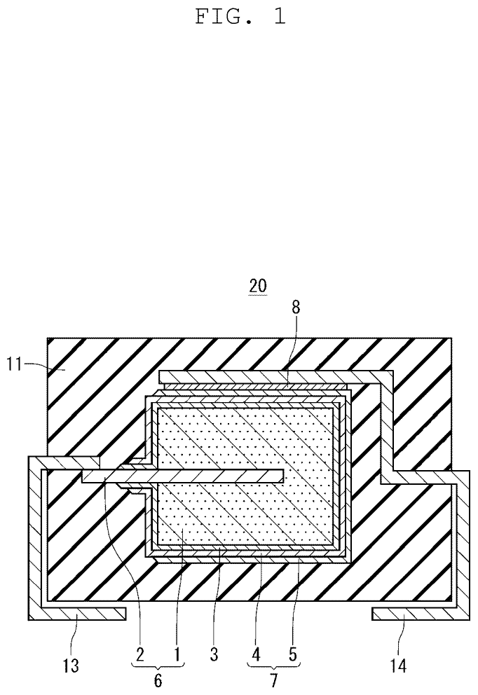

FIG. 1 is a schematic sectional view illustrating an electrolytic capacitor according to an exemplary embodiment of the present disclosure. Electrolytic capacitor 20 includes capacitor element 10 including anode part 6 and cathode part 7, exterior body 11 that seals capacitor element 10, anode lead frame 13 electrically connected to anode part 6, and cathode lead frame 14 electrically connected to cathode part 7.

Anode part 6 includes anode body 1 and anode wire 2. A part of anode wire 2 is embedded in anode body 1, and a remaining part protrudes outward from an outer surface of anode body 1. The protruding part of anode wire 2 is joined to a part of a first part of anode lead frame 13 by welding or the like to be electrically connected thereto.

Dielectric layer 3 is formed on a surface of anode body 1. Cathode part 7 includes solid electrolyte layer 4 covering at least a part of dielectric layer 3, and cathode lead-out layer 5 covering at least a part of a surface of solid electrolyte layer 4. Cathode lead-out layer 5 includes a carbon layer (first layer) formed covering at least a part of the surface of solid electrolyte layer 4, and a metal particle-containing layer (second layer) formed covering at least a part of the carbon layer. Then, a part of a first part of cathode lead frame 14 is bonded to cathode lead-out layer 5 with conductive adhesive layer 8 interposed therebetween, and is electrically connected to cathode lead-out layer 5.

### EXAMPLES

Although the present disclosure is specifically described below with reference to Examples and Comparative Examples, the present disclosure is not limited to the Examples below.

### Examples 1 to 3

### (1) Preparation of Electrolytic Capacitor

An electrolytic capacitor was prepared in the following manner.

### (First Step)

Tantalum metal particles were used as the valve metal. The tantalum metal particles were molded into a rectangular parallelepiped so that one end of an anode wire made of tantalum metal was embedded in the tantalum metal particles, and then the molded body was sintered in a vacuum. Consequently, an anode part was obtained, the anode part including an anode body composed of a porous sintered body of tantalum and an anode wire having one end embedded in the anode body and a remaining part planted from one surface of the anode body.

Subsequently, the anode body and a part of the anode wire planted from the anode body were immersed in an anodizing tank filled with a phosphoric acid aqueous solution as an electrolytic aqueous solution, and the other end of the anode wire was connected to the anode body in the anodizing tank. Then, anode oxidation was performed to form a uniform dielectric layer of tantalum oxide (Ta₂O₅) on the surface of the anode body (a surface of the porous sintered body including an inner wall surfaces of holes) and a part of a surface of the anode wire.

### (Second Step)

Next, 3,4-ethylenedioxythiophene (monomer), iron (III) p-toluenesulfonate, and 1-butanol were mixed to prepare a polymerization liquid. After the anode body was immersed in the polymerization liquid, the anode body was pulled up from the polymerization liquid, and heat treatment was performed in atmosphere. In this case, the p-toluenesulfonic acid iron (III) functions as an oxidant and a dopant. In this way, a monomer was polymerized on the dielectric layer to form a second conductive polymer layer containing poly(3,4-ethylenedioxythiophene) (PEDOT) by chemical polymerization. The anode body on which the second conductive polymer layer was formed was washed.

Subsequently, the washed anode body on which the second conductive polymer layer was formed was immersed in an aqueous dispersion liquid containing PEDOT as a conjugated polymer and polystyrene sulfonic acid (PSS, Mw=160,000) as a polymer dopant at a total concentration ranging from 2% by mass to 4% by mass. After the immersion, the anode body was taken out and subjected to drying treatment under atmospheric pressure. In this way, a first conductive polymer layer containing PEDOT and PSS was formed covering the second conductive polymer layer.

Subsequently, an aqueous solution containing a salt shown in Table 1 at a concentration shown in Table 1 was prepared. The anode body having the first conductive polymer layer obtained above was immersed in the aqueous solution, and taken out to be dried at 105° C. for 10 minutes. In this way, the anode body provided with the solid electrolyte layer containing a component derived from the salt shown in Table 1 was obtained.

### (Third Step)

A cathode lead-out layer including a carbon layer (first layer) and a silver paste layer (second layer) was formed by sequentially applying a carbon paste and a metal paste to a predetermined region of a surface of the second conductive polymer layer. In this way, a capacitor element was obtained.

An anode lead frame and a cathode lead frame were disposed on the capacitor element, and sealed with an epoxy resin sealing material to form an exterior body. Then, the anode lead frame and the cathode lead frame, which protruded from the exterior body, were bent along the exterior body to obtain electrolytic capacitors E1 to E3. Twenty electrolytic capacitors were prepared for each of Examples 1 to 3.

### (2) Evaluation

### (a) ESR

In an environment of 20° C., initial ESR (R0) (mΩ) of each electrolytic capacitor at a frequency of 100 kHz was measured using an LCR meter for 4-terminal measurement. Then, the initial ESR was acquired as an arithmetic average value of ten electrolytic capacitors.

A high-humidity test was performed by allowing the ten electrolytic capacitors, for each of which the initial ESR was measured, to stand for 1000 hours in a high-temperature and high-humidity environment (85° C. and 85% RH) while a voltage of 0.8 times the rated voltage was continuously applied. After the high-humidity test, the electrolytic capacitors were cooled to 20° C. ESR (R1) (μΩ) of each of the electrolytic capacitors after the cooling was measured under the same conditions as in the initial ESR measurement. For each of the electrolytic capacitors, ESR change value was acquired by dividing the ESR (R1) after the cooling after the high humidity test by the initial ESR (R0). An arithmetic average value (relative value) and a standard deviation were obtained from the ESR change values of the ten electrolytic capacitors.

### (b) Initial Leakage Current (LC)

A resistance of 1 kΩ was connected in series to each of the remaining ten electrolytic capacitors other than the ten electrolytic capacitors used in the ESR measurement, and a leakage current (μA) was measured after a rated voltage of 10 V was applied for twenty seconds with a DC power supply. A median value (μA) of leakage current values for the ten electrolytic capacitors was obtained.

### Comparative Example 1

In the second step, the anode body including the first conductive polymer layer was not immersed in the aqueous solution containing the salt and was not dried. Except for the above, an anode body provided with a solid electrolyte layer was prepared as in Example 1, and electrolytic capacitor C1 was prepared using the anode body and was evaluated.

### Comparative Example 2

In the second step, an aqueous solution containing phenolsulfonic acid was used instead of the aqueous solution containing the salt. Except for this, an anode body provided with a solid electrolyte layer was prepared as in Example 1, and electrolytic capacitor C2 was prepared using this anode body and was evaluated.

### Comparative Example 3

In the second step, a solid electrolyte layer including only the second conductive polymer layer was formed by chemical polymerization. That is, the first conductive polymer layer using the aqueous dispersion liquid was not formed. Polymerization time was adjusted to cause the solid electrolyte layer to have an average thickness that is nearly equal to the average thickness of the solid electrolyte layer in Example 1. Except for the above, an anode body provided with a solid electrolyte layer was prepared as in Example 1, and electrolytic capacitor C3 was prepared using the anode body and was evaluated.

Evaluation results are shown in Table 1. Table 1 shows electrolytic capacitors E1 to E3 that correspond Examples 1 to 3, respectively, and electrolytic capacitors C1 to C3 that correspond Comparative Examples 1 to 3, respectively.

TABLE 1

| | | | | | | | 85° C. 85% RH | |
|---|---|---|---|---|---|---|---|---|
| | | | | | | | after 1000 hours | |
| | | | | | | | ESR change | |
| | | | | | Initial properties | | average | |
| | | First | | | ESR | LC | value | ESR |
| | Second | conductive | Aqueous solution | | [mΩ] | [μA] | [Relative | change |
| | conductive | polymer | | Concentration | Average | Median | value to initial | standard |
| | polymer layer | layer | Salt | [mass %] | value | value | value 1] | deviation |
| E1 | Chemical | Dispersion | Phenolsulfonic | 5 | 62.5 | 0.8 | 1.2 | 1.1 |
| | polymerization | | acid Ba | | | | | |
| E2 | Chemical | Dispersion | Phenolsulfonic | 5 | 62.5 | 0.9 | 1.0 | 0.1 |
| | polymerization | | acid Ca | | | | | |
| E3 | Chemical | Dispersion | p-toluenesulfonic | 5 | 65.8 | 0.8 | 1.1 | 0.3 |
| | polymerization | | acid Ba | | | | | |
| C1 | Chemical | Dispersion | — | — | 55.9 | 0.8 | 24.0 | 60.6 |
| | polymerization | | | | | | | |
| C2 | Chemical | Dispersion | (Phenolsulfonic | (5) | 61.8 | 5341.8 | — | — |
| | polymerization | | acid) | | | | | |

| | | | | | | | |
|---|---|---|---|---|---|---|---|
| C3 | Chemical polymerization | Phenolsulfonic | 5 | 82.0 | 1.0 | 5.8 | 6.7 |

acid Ba

As shown in Table 1, the electrolytic capacitor including the first conductive polymer layer containing the component (in particular, the first metal element) derived from the compound (such as a salt) that generates the organic anion and the divalent metal ion, the first conductive polymer layer being formed using the aqueous solution containing the compound, shows the ESR that is reduced in fluctuation even after the electrolytic capacitor is exposed to a high-temperature and high-humidity environment for a long time (electrolytic capacitors E1 to E3). The amount of initial leakage current is also small (electrolytic capacitors E1 to E3). In contrast, electrolytic capacitor C1, in which the first conductive polymer layer does not contain the first metal element, shows a very large fluctuation in ESR and a very large variation in ESR value after the electrolytic capacitor is exposed to a high-temperature and high-humidity environment for a long time while the initial ESR is low. Electrolytic capacitor C2 using phenol sulfonic acid shows the initial ESR that is low to some extent, but shows a significant amount of initial leakage current. Thus, the high humidity test could not be performed. Electrolytic capacitor C3, in which the solid electrolyte layer is formed only of the chemically polymerized film, shows the initial ESR that is higher than that of each of electrolytic capacitors E1 to E3 even when using the above-mentioned compound (salt or the like), the amount of fluctuation of the ESR after the high humidity test that is also large, and the variation in the ESR value that is also large.

Electrolytic capacitor E2 of Example 2 was also subjected to element mapping of a section using the EPMA according to the procedure described above. In the electrolytic capacitor immediately after preparation, Ca elements and S elements were relatively uniformly dispersed in a part of the first conductive polymer layer. The electrolytic capacitor subjected to the high humidity test for the ESR measurement was subjected to the element mapping as in the description above. As a result, the S elements were distributed throughout the first conductive polymer layer, and the Ca elements were segregated on an interface between the solid electrolyte layer and the carbon layer (first layer) of the cathode lead-out layer.

According to the electrolytic capacitor and the method for manufacturing the electrolytic capacitor of the present disclosure, an increase in ESR when the electrolytic capacitor is exposed to a relatively high temperature (or a relatively high temperature and high humidity environment) can be reduced. The solid electrolytic capacitor of the present disclosure is capable of securing low ESR stably even when exposed to a relatively high temperature for a long time, and thus can be used for various applications in which heat resistance, moisture resistance, or reliability is required. However, the application of the electrolytic capacitor is not limited to these.

What is claimed is:

1. A method for manufacturing an electrolytic capacitor including a capacitor element containing a solid electrolyte, the method comprising the steps of:
preparing an anode body that includes a dielectric layer provided on a surface of the anode body; and
forming a solid electrolyte covering at least a part of the dielectric layer, wherein:
the step of forming the solid electrolyte includes:
substep A of bringing a treatment liquid containing a conjugated polymer and a polymer dopant into contact with the anode body, and
at least one of (i) or (ii) below,
(i) substep B is further performed after the substep A to bring an aqueous solution containing a compound that generates an organic anion and a divalent metal ion into contact with the anode body, the divalent metal ion not including a divalent transition metal ion, and
(ii) substep C is further performed before the substep A to prepare the treatment liquid by mixing an aqueous solution containing a compound that generates an organic anion and a divalent metal ion with a liquid composition containing the conjugated polymer and the polymer dopant, the divalent metal ion not including a divalent transition metal ion.

2. The method according to claim 1, wherein the organic anion includes an aromatic sulfonate anion.

3. The method according to claim 1, wherein the divalent metal ion is at least one kind of ion selected from the group consisting of a barium ion, a calcium ion, and a magnesium ion.

4. The method for manufacturing an electrolytic capacitor according to claim 1, wherein:
the step of forming the solid electrolyte further includes substep D of polymerizing a precursor of a conjugated polymer in presence of a dopant while a polymerization liquid containing the precursor and the dopant is in contact with the anode body, and
the substep A is performed after the substep D.

5. The method according to claim 1, wherein a concentration of the compound that generates the organic anion and the divalent metal ion in the aqueous solution in (i) ranges from 1% by mass to 10% by mass, inclusive.

6. The method according to claim 1, wherein a concentration of the compound that generates the organic anion and the divalent metal ion in the treatment liquid in (ii) ranges from 0.2% by mass to 3.0% by mass, inclusive.

7. The method according to claim 1, the method further comprising the step of subjecting the anode body to heat treatment after the substep A, or after the substep B when the substep B is performed,
wherein in the step of subjecting the anode body to heat treatment, the heat treatment is performed at a temperature ranging from 80° C. to 150° C., inclusive, for five minutes or more.

8. An electrolytic capacitor including a capacitor element containing a solid electrolyte, the electrolytic capacitor comprising:
an anode body that includes a dielectric layer provided on a surface of the anode body; and
a solid electrolyte covering at least a part of the dielectric layer, the solid electrolyte containing a metal element corresponding to a divalent metal ion, the divalent metal ion not including a divalent transition metal ion, wherein:
the solid electrolyte includes a first conductive polymer layer containing a conjugated polymer, a polymer dopant, and the metal element, and
the metal element is dispersed throughout the first conductive polymer layer.

9. The electrolytic capacitor according to claim 8, wherein the metal element is at least one kind of element selected from the group consisting of a barium element, a calcium element, and a magnesium element.

10. The electrolytic capacitor according to claim 8, wherein:
the solid electrolyte further includes a second conductive polymer layer covering at least a part of the dielectric layer, the first conductive polymer layer covering at least a part of the second conductive polymer layer,
the second conductive polymer layer contains a conjugated polymer and a dopant, and
a content ratio of the metal element in the first conductive polymer layer is higher than a content ratio of the metal element in the second conductive polymer layer.

11. The electrolytic capacitor according to claim 8, wherein:
the electrolytic capacitor includes a carbon layer covering at least a part of a surface of the first conductive polymer layer, and
in the electrolytic capacitor after being allowed to stand at 85° C. and 85% RH for 1000 hours while a voltage of 0.8 times a rated voltage is applied, the metal element is segregated on an interface between the first conductive polymer layer and the carbon layer in the first conductive polymer layer.
